(19) United States
(12) Patent Application Publication
(10) Pub. No.: US 2007/0091814 A1
(43) Pub. Date: Apr. 26, 2007

(54) Testing system and method for testing functions of wireless devices

(76) Inventors: Hung Fung Leung, Kowloon (HK); Kent Beck, Greenacres, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/255,014

(22) Filed: Oct. 21, 2005

(51) Int. Cl. H04J 1/16

(52) U.S. Cl. 370/252

(57) ABSTRACT

A testing system is provided with a wireless device; and a testing device arranged to receive digital data representing an actual fading profile of a selected geographic region, and to perform testing of the wireless device using the actual fading profile of the specific geographic region. As a result, all types of testing including BER, video-call testing or real-time data transfer, error resilience tolerance over video streamlining data for a specific geographic region, such as Hong Kong environment (urban, suburban, underground, highway, etc..) can be performed accurately and reliably.

### BACKGROUND

In communications systems, communication quality between a base station transmitter and mobile (or stationary) receiver depends on a number of factors, including the general quality of the propagation channel through which the signal passes. In wireless applications, and especially cellular communications, wireless signals passing through terrestrial air are distorted by atmospheric impairments, disrupted by natural obstacles (such as trees, mountains, bodies of water) and man-made obstacles (such as buildings, billboards, streets), and further changed by the relative motion of transmitter and receiver. This process is known as “fading” which can be characterized as “large-scale fading” for channel propagation over long distances, and “small scale fading” for effects that are found near to the receiver antenna.

Large scale fading includes both the average attenuation of a wireless signal as it travels a long distance, and signal diffraction by large objects such as mountains or skyscrapers. In addition to the path loss over large distances, the receiver antenna will also experience fluctuations in signal level that vary significantly over small distances due to multipath propagation and Doppler shift. Multipath fading occurs because a signal being transmitted can take different paths to the receiver after encountering objects such as mailboxes, trees, and moving vehicles, causing reflection, diffraction, and local scattering. As a result, the receiver can receive multiple copies of a signal at different arrival times, at different phases and power levels, causing signal power to fluctuate and spread in terms of frequency (amplitude and phase) and time. Doppler-shift fading is the result of motion. If a receiver is moving in relation to a transmitter, the incoming signal can vary in frequency depending on its direction relative to the receiver. Signal copies that arrive along paths directly in front of the receiver can be detected as a higher frequency than the transmitted signal, while signal copies that arrive along paths behind the moving receiver can be detected as a lower frequency. Both the large scale fading and the small scale fading can reduce the signal-to-noise ratio (SNR), cause intersymbol interference (ISI) making accurate interpretation of the received symbols more difficult, and create synchronization problems in phase locked loops.

There are several techniques that can be employed in the design of wireless devices to reduce the effects of fading. For example, a bit rate used for transmission can be chosen to reduce avoidable errors if a specific type of fading is known in the transmission channel. Channel equalization may also be used to mitigate distortion. Interleaving and encoding can further be used to reduce carrier-to-noise required for accurate detection. In. addition, there are transmission technologies, such as ultra wideband (UWB) and Orthogonal Frequency Division Multiplexing (OFDM), whose signaling properties can avoid the most common effects of fading. Moreover, simulation tools have been used to simulate the transmission channel conditions that mimic large-scale and small-scale fading to ensure the receiver is robust and provide communications under those realistic fading conditions in order to perform testing of mobile handsets, personal digital assistants (PDAs) and other wireless devices and subsystems. Typically, traditional fading simulators require digitizing an incoming RF signal, then fading the same via a required fading profile reflecting the environment to be simulated, and then converting it back to an RF signal. However, all required steps can lead to inefficiency and inaccuracy because of noise calibration and conversion loss associated with non-linear distortion in the DAC, quantization error, clipping, sampling misinterpretation, carrier feed-through, and others.

A more recent advanced simulation tool is known as an AGILENT 8960 mobile test set which utilizes a PC containing a PCI card (not shown) and fading simulation software (not shown), to provide fading simulations for testing of wireless devices in the digital domain. FIG. 1 illustrates an example testing system 100 utilizing an AGILENT 8960 mobile test set. As shown in FIG. 1, the testing system 100 includes a control computer 110, an AGILENT 8960 mobile test set serving as a testing device 120, and a device under test (DUT) 130 such as a mobile phone. The control computer 110 contains a testing program including fading simulation software, and generally, is connected with the testing device 120, via a general purpose interface bus (GPIB) cable 112. A radio-frequency (RF) port of the testing device 120 is connected with an antenna terminal of the DUT 130 via a radio-frequency (RF) cable 122 or other transmission means. In general, a communication link is established between the testing device 120 and the DUT 130. A test request is typically sent from the testing program inside the control computer 110 to the testing device 120 for a specific function. The testing device 120 then performs testing of the DUT 130 and sends a test result back to the control computer 110 after the test is complete. Finally, the test result is displayed on the screen of the control computer 110 and stored in a data file for the user to confirm. For fading tests that are required in the major cellular communications standards such as 3GPP (3^{rd} Generation Partnership Project) and 3GPP2 specifications including GSM (Global System for Mobile Communications), W-CDMA (Wideband Code Division Multiple Access), TD-SCDMA, CDMA2000, FDMA (Frequency Division Multiple Access), TDMA (Time Division Multiple Access), EDGE (Enhanced Data Rates for Global Evolution), HSDPA (High Speed Downlink Packet Access), HSUPA (High Speed Uplink Packet Access) and WLAN (Wireless Local Area Network) standards, different pre-defined fading models may be utilized at the control computer 110, as shown in FIG. 1, to provide real-time fading simulation and to evaluate receiver performance in a variety of environments. These standard pre-defined fading models may include: (1) Rayleigh for small-scale multipath scattering: (2) Rician for Rayleigh with a direct path; (3) Log Normal for large scale free space path loss; (4) Suzuki for Rayleigh with log normal; (5) Pure Doppler for frequency shift due to motion; and (6) Constant Phase for changing phase and delay of a transmission path for simulating specific small scale and/or large scale fading environments. However, there is no testing system and no fading model for mobile testing under specific geographical locations. As a result, the customer must travel and spend time to conduct field testing on mobile data or video-call communication.

Accordingly, there is a need for a new testing system in which an actual fading profile of a selected geographic region can be obtained at a mobile testing device, and a wireless device can be tested for functionality at the mobile testing device using the actual fading profile. In addition, there is also a need to provide the customer with the ability to perform testing of a wireless device, such as, bit error rate (BER), video-call connection, real-time data transfer, SMS, MMS, data security, and benchmarking a new mobile phone in accordance with all major cellular communications standards such as, for example, GSM, W-CDMA, TD-SCDMA, CDMA2000, FDMA, TDMA, EDGE, HSDPA, HSUPA and WLAN standards.

### SUMMARY

Various aspects and example embodiments of the present invention provide a testing system and methods in which digital data representing an actual fading profile of a selected geographic region can be obtained in advance, and a wireless device can be tested for functionality at a mobile testing device using the actual fading profile.

In accordance with an aspect of the present invention, a testing system is provided with a wireless device, and a mobile testing device arranged to receive digital data representing an actual fading profile of a selected geographic region, and to perform testing of the wireless device using the actual fading profile. A computer is further provided to connect with the testing device, via a cable, or alternatively, via a network, to download digital data representing an actual fading profile into the testing device.

The digital data representing an actual fading profile can be recorded on a computer readable medium, such as a magnetic medium (e.g., fixed, floppy and removable disk and magnetic tape), or an optical medium (e.g., compact disc, CD-R, CD-R/W or digital video disc, DVD-R/W, HD-DVD, Blu-ray and other advanced optical disks). The testing device is provided with an arbitrary waveform generator to generate an analog baseband signal based on the digital data representing an actual fading profile, and a frequency converter to convert the analog baseband signal into a high-frequency RF signal suitable for transmission, via a transmission channel, to the wireless device, along with a standard protocol required for the wireless device to decode the RF signal upon its receipt. Similarly, the wireless device is configured to receive and decode the RF signal according to the standard protocol transmitted from the testing device, and then send back to the testing device an RF signal for RF testing or other testing purposes, such as bit error rate (BER) testing and block error rate (BLER) testing.

The testing device comprises a memory to store digital data representing an actual fading profile; a controller configured to perform testing of the wireless device using the digital data stored in the memory; an arbitrary waveform generator to generate an analog baseband signal based on the digital data stored in the memory; and an RF transceiver arranged to convert the analog baseband signal into a high-frequency RF signal and transmit the RF signal, via a RF port, to the wireless device along with a standard protocol required for the wireless device to decode the RF signal upon its receipt and send back for RF testing and other testing purposes, including bit error rate (BER), block error rate (BLER), video-call connection, real-time data transfer, SMS, MMS, data security testing, and benchmarking a new mobile phone in accordance with major cellular communications standards including GSM, W-CDMA, TD-SCDMA, CDMA2000, FDMA, TDMA, EDGE, HSDPA, HSUPA and WLAN standards.

According to another aspect of the present invention, a mobile testing device is provided with a memory to store digital data representing an actual fading profile of a selected geographic; an arbitrary waveform generator to generate an analog baseband signal based on the digital data stored in the memory; an RF transceiver arranged to convert the analog baseband signal into a high-frequency RF signal, to transmit the RF signal, via one or more RF ports, to a wireless device along with a standard protocol required for the wireless device to decode the RF signal upon its receipt, and to receive a RF signal sent back from the wireless device; and a controller configured to perform testing of the wireless device based on the RF signal sent back from the wireless device.

In accordance with another aspect of the present invention, a method is provided for testing a wireless device utilizing a mobile testing station. Such a method comprises: obtaining digital data representing an actual fading profile of a selected geographic region; generating an analog baseband signal based on the digital data obtained; converting the analog baseband signal into a high-frequency RF signal, and transmitting the RF signal, via a RF link, to a wireless device along with a standard protocol required for the wireless device to decode the RF signal upon its receipt; and performing testing of the wireless device based on a RF signal sent back from the wireless device, via the RF link.

In accordance with yet another aspect of the present invention, a computer readable medium is provided with a plurality of instructions which, when executed by a mobile testing station, perform the steps of: obtaining digital data representing an actual fading profile of a selected geographic region; generating an analog baseband signal based on the digital data obtained; converting the analog baseband signal into a high-frequency RF signal, and transmitting the RF signal, via a RF link, to a wireless device along with a standard protocol required for the wireless device to decode the RF signal upon its receipt; and performing testing of the wireless device based on a RF signal sent back from the wireless device, via the RF link.

In addition to the example embodiments and aspects as described above, further aspects and embodiments will be apparent by reference to the drawings and by study of the following descriptions.

### BRIEF DESCRIPTION OF THE DRAWING(S)

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates an example testing system utilizing AGILENT 8960 mobile test set to provide fading simulations and testing of wireless devices;

FIGS. 2A-2C illustrate an example fading profile of a specific geographic location obtained according to an embodiment of the present invention;

FIG. 3 illustrates an example testing system for testing a wireless device using an actual fading profile of a specific geographic location according to an embodiment of the present invention;

FIG. 4 illustrates an example testing device according to an embodiment of the present invention;

FIG. 5 illustrates an example testing device according to another embodiment of the present invention;

FIG. 6 illustrates an example testing operation between a testing device and a device under test (DUT) according to an embodiment of the present invention; and

FIG. 7 illustrates a flowchart of an example complete testing operation according to an embodiment of the present invention.

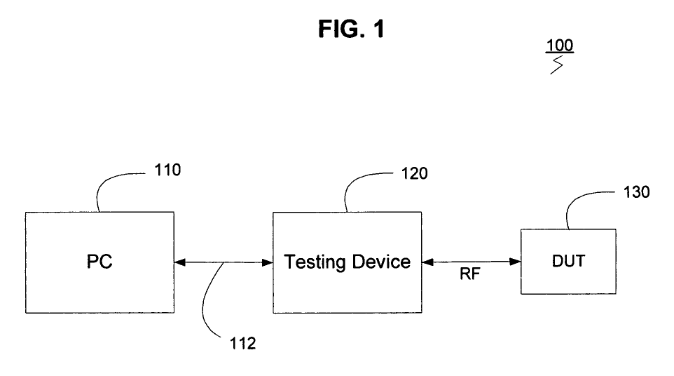

### DETAILED DESCRIPTION

Before beginning a detailed description of the subject invention, mention of the following is in order. When appropriate, like reference numerals and characters may be used to designate identical, corresponding or similar components in differing figure drawings. Further, in the detailed description to follow, example sizes/values/ranges may be given, although the present invention is not limited to the same. The present invention is applicable for use with all types of wireless communication devices and wireless networks in compliance with cellular communications standards such as GSM, W-CDMA, TD-SCDMA, CDMA2000, FDMA, TDMA, EDGE, HSDPA, HSUPA and WLAN standards. The testing program can be created with AGILENT's Advanced Design System (ADS), MATLAB™, C++, or Labview program language for controlling a testing device and for testing all the functions of wireless devices. The present invention can also be characterized as having two different stages: (1) “drive-test data collection stage” where drive-test data (i.e., actual RF signals received from a single or multiple base stations) indicating actual fading conditions, including large-scale and small-scale fading of a specific geographic region (e.g., Hong Kong, Taipei, or Washington DC) are obtained to develop an actual fading profile; and (2) “mobile testing stage” where a wireless device is tested for functionality at a mobile testing device utilizing the actual fading profile.

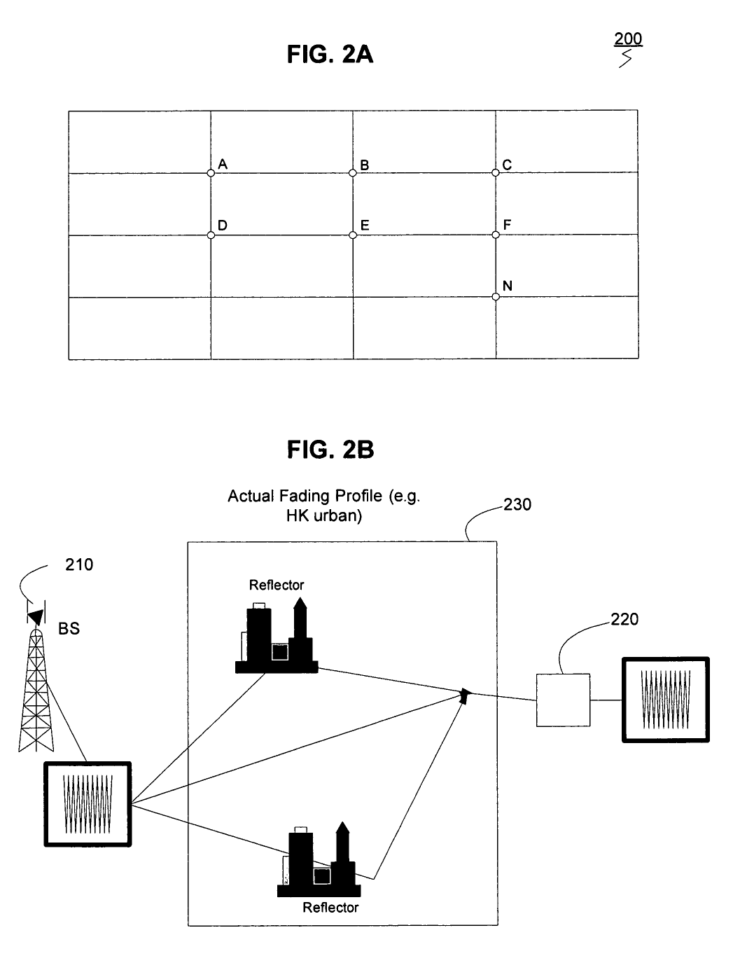

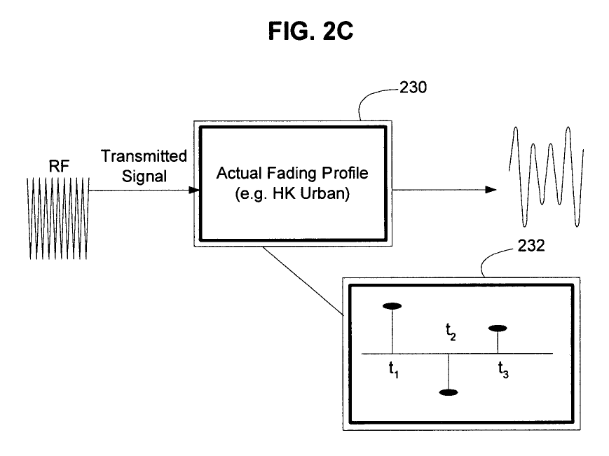

Attention now is directed to the drawings and particularly to FIGS. 2A-2C, in which an example fading profile of a specific geographic region obtained according to an embodiment of the present invention is illustrated. Specifically, FIG. 2A illustrates an example contour map 200 of a specific geographic region or location, such as Hong Kong, which can be broken down into different points or locations of testing, for example, “A”, “B”, “C”. . . “N” (where “N” is an integer) using cellular communications standards such as GSM, W-CDMA, TD-SCDMA, CDMA2000, EDGE, HSDPA, HSUPA and WLAN standards. FIG. 2B illustrates an example transmission of a RF signal from a designated base station 210 (or multiple base stations) to a mobile measurement instrument 220 located at a designated point of testing within the specific geographic region, where actual fading conditions can be observed, collected, and down-converted from high frequency to baseband I/Q form for easy digital storage/recording in terms of signal strengths to obtain an actual fading profile 230. FIG. 2C illustrates an example actual fading profile 230 of a specific geographic region obtained at the mobile measurement instrument 220 by collecting drive testing data, i.e., an RF signal transmitted from the base station 210 over a designated time period, for example, several minutes, at time window,232, for example, t1, t2 and t3, at point “A” of the specific geographic region, such as Hong Kong, Taipei, or Washington DC.

According to an example embodiment of the present invention, the mobile measurement instrument 220, as shown in FIG. 2B, can be a hand-held equipment such as AGILENT E7495 Base Station Tester, or alternatively, a wideband vector spectrum analyzer 220 which can be carried by a technician standing at point “A” of a specific geographic region, such as Hong Kong, and/or moving from point “A” to point “B” to receive an RF signal transmitted from the base station 210 over a designated time period. Such a vector spectrum analyzer 220 can capture and digitize the RF signal transmitted from the base station 210. The captured RF signal from one or more locations in a specific geographic region can then undergo frequency down-conversion (i.e., digital demodulation) into baseband I/Q digital data, which can be measured in terms of magnitude and phase in both the frequency and time domains to represent an actual fading profile 230, and then recorded in an internal memory device or a computer readable medium attachable to the vector spectrum analyzer 220. Such a computer readable medium may correspond to non-volatile memory including, but not limited to: a semiconductor memory device such as erasable programmable read-only-memory (EPROM, EEPROM, flash memory and memory stick); a magnetic disk (fixed, floppy, and removable); other magnetic medium such as diskette and tape; and an optical medium such as CD-ROM, CD-R, CD-R/W or digital video disc, DVD-R/W, HD-DVD, Blu-ray and other advanced optical disks. It should be noted that the larger the volume of digital data collected during the drive-test data collection stage, the larger the capacity the computer readable medium would be required.

Traditional swept-tuned spectrum analyzers can also be utilized as a mobile measurement instrument 220; however, these traditional swept-tuned spectrum analyzers may require lengthy sweep times for narrow resolution bandwidths due to the sweep rate of the narrow filters. As a result, a vector spectrum analyzer is more equipped to make narrow band measurements quickly in a vector mode, especially measurement from a narrow span of 1 HZ to a wide span of greater than 30 MHz with a resolution bandwidth from 1 mHz to 10 MHz. Such a vector spectrum analyzer can utilize FFT (Fast Fourier Transform) to convert an RF signal received from the base station 210 from the time domain to the frequency domain, which can be 1000 times faster than traditional swept spectrum analyzers. In addition, the vector spectrum analyzer is also better equipped to handle possible handoff and capture an RF signal transmitted from the base station 210, when the technician is moving between various points or locations within the specific geographic region while receiving the RF signal transmitted from the base station 210 without interruption.

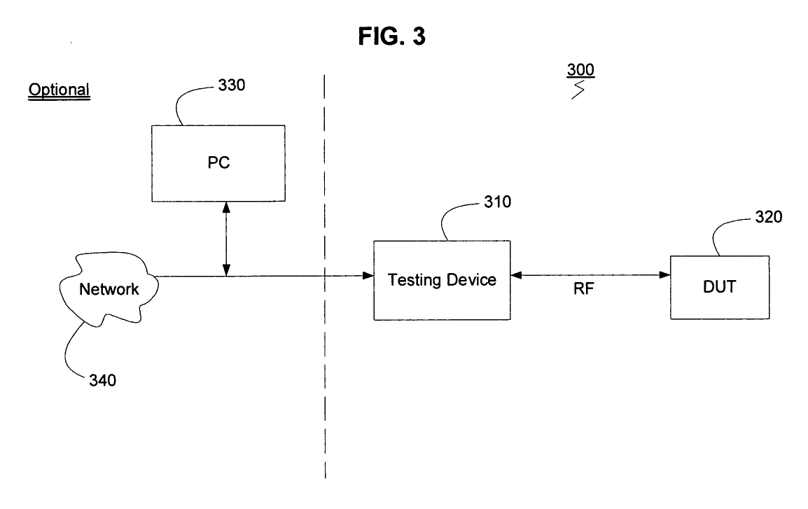

Turning now to FIG. 3, an example testing system for testing a wireless device using an actual fading profile of a specific geographic location according to an embodiment of the present invention is illustrated. As shown in FIG. 3, the testing system 300 includes a testing device 310 and a device under test (DUT) 320 such as a mobile phone, PDA, pager or any other wireless device. At least one radio-frequency (RF) port of the testing device 310 is connected with an antenna terminal of the DUT 320, via a radio-frequency (RF) cable or other transmission means, to establish a communication link between the mobile testing device 310 and the DUT 320. Optionally, a host computer 330 can be utilized to connect directly with the testing device 310, via a GPIB cable, or indirectly, via a network 340 such as the Internet, to download I/Q digital data representing an actual fading profile 230 onto the testing device 310 for mobile testing of a DUT 320 such as a mobile phone. Such mobile testing may include, for example, video-call connection, real-time data transfer, SMS, MMS, data security testing, and benchmarking a new mobile phone in accordance with all major cellular communications standards, such as, for example, GSM, W-CDMA, TD-SCDMA, CDMA2000, FDMA, TDMA, EDGE, HSDPA, HSUPA and WLAN standards. As previously discussed, the I/Q digital data representing an actual fading profile 230 can be recorded on a computer readable medium (e.g., a hard drive media, optical media, EPROM, EEPROM, tape media, cartridge media, flash memory, ROM, memory stick, and/or the like), and downloaded into the testing device 310.

The testing device 310 is a mobile testing station arranged to communicate with the DUT 320, i.e., to receive and transmit a RF signal to the DUT 320, via a RF cable or other transmission means (wire or wireless) used to establish a RF link between the testing device 310 and the DUT 320. The RF signal may be transmitted in accordance with all major wireless communications standards such as, for example, GSM, W-CDMA, TD-SCDMA, CDMA2000, FDMA, EDGE, HSDPA, HSUPA and WLAN standards. Examples of such wireless communications may include, but not limited to, infrared, microwave and all ranges of the electromagnetic spectrum, sound wave communication, laser and all other optical communication methods, as well as inductive, capacitive and all other forms of electromagnetic effect communication. The testing device 310 can be configured to receive digital data representing an actual fading profile 230, and to perform testing of the DUT 320 using the actual fading profile 230. In particular, the testing device 310 is configured to generate an analog baseband signal based on the digital data representing an actual fading profile 230 of the selected geographic region, and to convert the analog baseband signal into a high-frequency RF signal suitable for transmission, via one or more RF ports, to the DUT 320, along with a standard (essential) protocol required for the DUT 320 to decode the RF signal upon its receipt. The DUT 320 may, in turn, receive and decode the RF signal according to the standard protocol transmitted from the testing device 310, and then send back to the testing device 310 an RF signal for RF testing and other testing purposes, including, for example, bit error rate (BER) testing or block error rate (BLER) testing of a mobile phone.

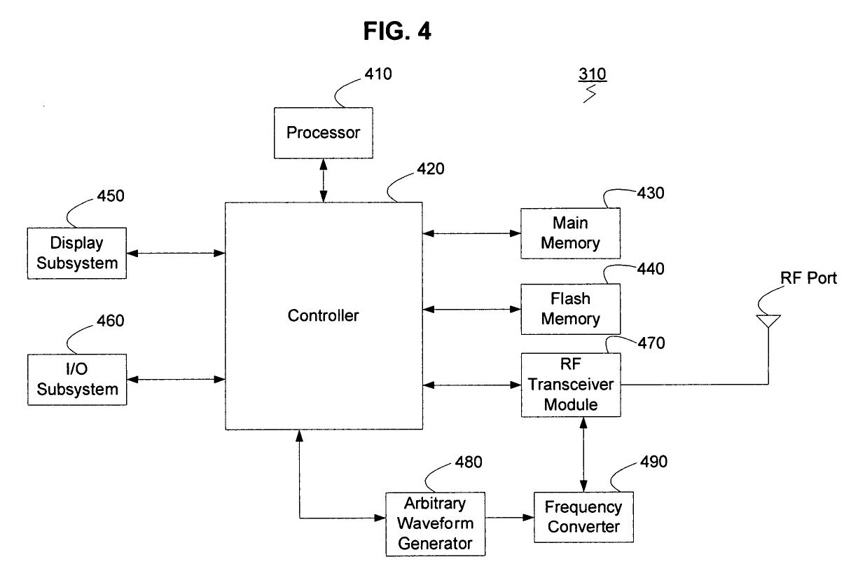

FIG. 4 illustrates an example system platform of a testing device 310 according to an embodiment of the present invention. As shown in FIG. 4, the testing device 310 may include a processor (CPU) 410; a controller 420 connected to the processor (CPU) 410; a main memory 430 and a flash memory 440 connected to the controller 420; a graphics/display subsystem 450 connected to the controller 420; an I/O subsystem 460 connected to the controller 420, via a peripheral bus; a RF transceiver module 470 connected to the controller 420, an arbitrary waveform generator 480 and a frequency converter 490 connected to the controller 420 and the RF transceiver module 470.

The processor (CPU) 410 controls operation for the testing device 310. The processor (CPU) 410 may include any one of Intel™ i386, i486, Celeron™or Pentium™ processors as marketed by Intel™ Corporation, K-6 microprocessors as marketed by AMD™, 6×86MX microprocessors as marketed by Cyrix™ Corporation, Alpha™ processors as marketed by Digital Equipment Corp.,™ 680x0 processors as marketed by IBM™. The controller 420 is configured to access to the main memory 430, to execute the testing program stored therein to perform all testing functions of a DUT 320, and to respond to operation of all I/O devices, via the I/O subsystem 450.

The main memory 430 may correspond to a dynamic random-access-memory (DRAM), but may be substituted for read-only-memory (ROM), video random-access-memory (VRAM), synchronous dynamic random-access-memory (SDRAM) and the like. Such a memory 430 may also include a non-volatile memory (not shown) such as a read-only-memory (ROM) to store an operating system (OS) and a testing program for use to perform different types of testing of a DUT 320; and a volatile memory (not shown) such as a random-access-memory (RAM) or a static random-access-memory (SRAM) to store temporary information for use by the processor (CPU) 410. The operating system (OS) may include any type of OS, including, but not limited to, Disk Operating System (DOS), Windows™, Unix, Linux, OS/2 and OS/9 for use by the processor (CPU) 410. The flash memory 440 (e.g., ROM and EEPROM) may contain a set of system basic input/output start-up instructions (system BIOS) as well as other applications that may execute during boot up (start-up) before the operating system (OS) is loaded.

The graphics/display subsystem 450 may include, for example, a graphics controller, a local memory and a display monitor. The IO subsystem 460 may include an input/output (I/O) adapter, a communications adapter, and a user interface adapter, and provide the chipset 420 an interface with a variety of I/O devices and the like, such as: a Peripheral Component Interconnect (PCI) bus connected to PCI slots, an Industry Standard Architecture (ISA) or Extended Industry Standard Architecture (EISA) bus option, and a local area network (LAN) option which may support one or more PCI compliant devices (such as modems, network interface cards, scanners, personal digital assistants etc.); a plurality of Universal Serial Bus (USB) ports (USB Specification, Revision 2.0 as set forth by the USB Special Interest Group (SIG) on Apr. 27, 2000); and a plurality of Integrated Drive Electronics (IDE) ports for receiving one or more magnetic hard disk drives (HDDs) or floppy disk drives (FDDs). The USB ports and IDE ports may be used to provide an interface to a hard disk drive (HDD), a compact disk read-only-memory (CD-ROM), a readable and writeable compact disk (CDRW), and a digital audio tape (DAT) reader to receive a storage medium (e.g., a hard drive media, optical media, EPROM, EEPROM, tape media, cartridge media, flash memory, ROM, memory stick, and/or the like) containing therein I/Q digital data collected at various points or locations within a specific geographic region to represent an actual fading profile 230 of that specific geographic region.

The I/O subsystem 460 may provide the controller 420 an interface with another group of I/O devices such as, a keyboard controller for controlling operations of an alphanumeric keyboard, a cursor control device (e.g., a mouse, track ball, touch pad, joystick, etc.), and a storage medium (e.g., a hard drive media, optical media, EPROM, EEPROM, tape media, cartridge media, flash memory, ROM, memory stick, and/or the like). As previously discussed, the storage medium is used to store I/Q digital data representing an actual fading profile 230 of a specific geographic region.

The RF transceiver module 470 includes both a transmitter and a receiver used to transmit and/or receive a RF signal, via a RF port, for testing functionalities of a DUT 320 such as, a mobile phone. In accordance with an embodiment of the present invention, one or more channelization schemes, such as Time Division Multiple Access (TDMA), Code Division Multiple Access (CDMA), or Frequency Division Multiple Access (FDMA), may be used to differentiate one or more channels used by one wireless device from the one or more channels used by another wireless device. Alternatively, the same channelization scheme may be used by the testing device 310 to differentiate RF signals transmitted and received by one wireless device from RF signals transmitted and received by another wireless device. In accordance with another embodiment of the present invention, the testing device 310 may utilize a customized or non-standard technique to simultaneously test multiple wireless devices.

In the embodiment shown in FIG. 3, the RF transceiver module 470 is used to transmit and receive one or more broadcast channels required for camping and initial signaling. Each DUT 320 may be assigned to a different traffic channel for functional testing.

The arbitrary waveform generator 480 is provided to generate an analog baseband signal in response to the controller 420 based on input digital data representing an actual fading profile 230 of a selected geographic region. As previously discussed, the digital data representing an actual fading profile 230 can be stored either in the storage medium, or alternatively, downloaded from a host computer 330 directly thereto, or via a network 340, such as the Internet. In addition, the arbitrary waveform generator 380 also provides standard protocol (i.e., security information or other information used to establish connection) designated for the DUT 320 to decode a RF signal transmitted from the RF transceiver module 470 of the testing device 310, upon its receipt. It should be noted that the larger the volume of digital data representing an actual fading profile 230 of a selected geographic location collected, the larger the memory capacity of the arbitrary waveform generator 480 would be required.

The frequency converter 490 is configured, in response to the controller 420, to convert (i.e., modulate) the analog baseband signal from the arbitrary waveform generator 480 into a high-frequency RF signal suitable for the RF transceiver module 470 to transmit, via a RF port, to the DUT 320, along with a standard (essential) protocol required for the DUT 320 to decode the RF signal upon its receipt.

Such a testing device 320, as shown in FIG. 4, can also be implemented using the AGILENT 8960 mobile test set. However, these AGILENT 8960 mobile test sets do not utilize an arbitrary waveform generator. As a result, an arbitrary waveform generator 480, and possibly, a frequency converter 490 and a testing program need to be incorporated to perform testing functions as required.

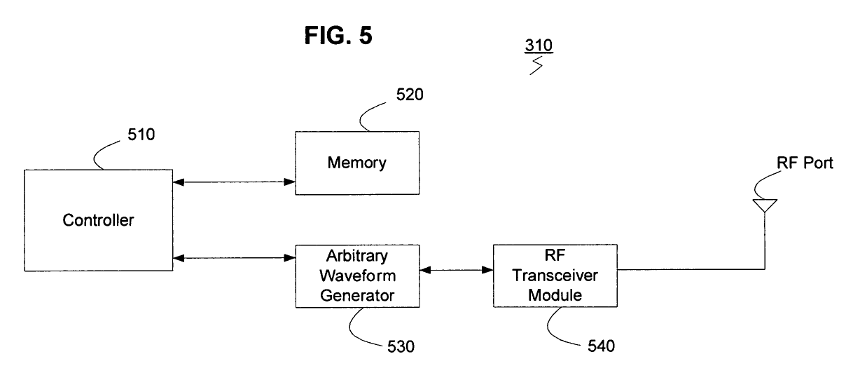

FIG. 5 illustrates another example system platform of a testing device 310 according to another embodiment of the present invention. As shown in FIG. 5, the testing device 310 can be provided with a controller 510, a memory 520, an arbitrary waveform generator 530, and a RF transceiver module 470. The controller 510 can be programmed to perform selected functional testing of a DUT 320 utilizing digital data representing an actual fading profile 230 of a selected geographic region, stored in the memory 520. The arbitrary waveform generator 530 is used to generate an analog baseband signal based on the digital data recorded in the memory 520, and combine thereto the standard (essential) protocol. The RF transceiver module 540 is then used to convert the analog baseband signal into a high-frequency RF signal suitable for transmission, via one or more RF ports, to the DUT 320, along with the standard protocol required for the DUT 320 to decode the RF signal upon its receipt. As previously discussed, the DUT 320 may, in turn, receive and decode the RF signal according to the standard protocol transmitted from the testing device 310, and then send back to the testing device 310 an RF signal for testing purposes, including, for example, bit error rate (BER) testing of a mobile phone, video-call connection, real-time data transfer, SMS, MMS, data security testing, and benchmarking new mobile phones in accordance with all major cellular communications standards such as, for example, GSM, W-CDMA, TD-SCDMA, CDMA2000, FDMA, TDMA, EDGE, HSDPA, HSUPA and WLAN standards.

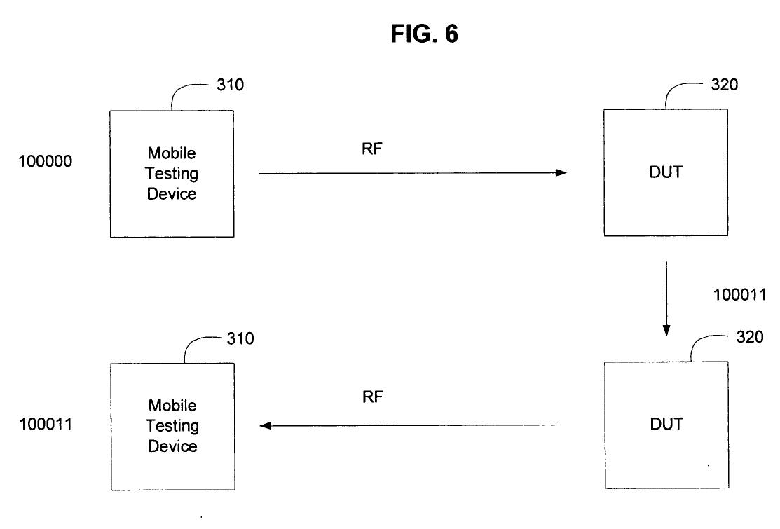

FIG. 6 illustrates an example testing operation, such as bit error rate (BER), between a testing device 310 and a DUT 320 according to an embodiment of the present invention. As shown in FIG. 6, upon a user request for a bit error rate (BER), the testing device 310 utilizes digital data representing an actual fading profile 230 of a selected geographic region previously collected and recorded to generate a RF signal modulated with intelligence, for example, “100000” for transmission, via one or more RF ports, to the DUT 320 during a downlink. The DUT 320 receives and decodes the RF signal transmitted from the testing device 310. The decoded data may represent “100011” which contains 2 bit errors. The DUT 320 then sends back to the testing device 310 the decoded data, also in the form of an RF signal during an uplink. Based on the receipt, the testing device 310 can determine the bit rate error (BER) accurately. Similarly, different types of testing, including, for example, video-call connection, real-time data transfer, SMS, MMS, data security testing, and benchmarking new mobile phones in accordance with all major cellular communications standards such as, for example, GSM, W-CDMA, TD-SCDMA, CDMA2000, FDMA, TDMA, EDGE, HSDPA, HSUPA and WLAN standards can also be performed in the same way.

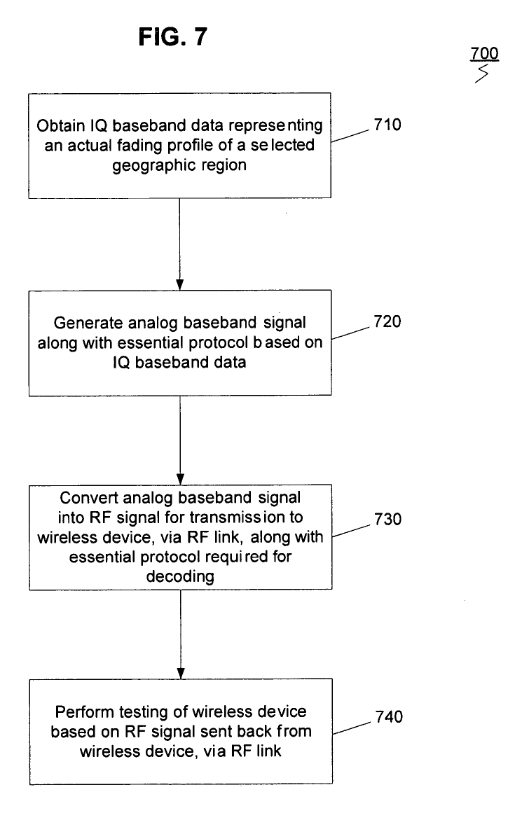

Turning now to FIG. 7, a flowchart of a complete testing operation at a mobile testing device according to an embodiment of the present invention is illustrated. As shown in FIG. 7, the testing operation at a mobile testing device includes obtaining I/Q baseband data represent an actual fading profile 230 of a selected geographic region at block 710; generating an analog baseband signal based on the digital data obtained along with a standard (essential) protocol at block 720; converting the analog baseband signal into a high-frequency RF signal for transmission to a wireless device, via a RF link, along with the standard protocol required for the wireless device to decode the RF signal upon its receipt at block 730; and performing testing of the wireless device based on a RF signal sent back from the wireless device, via the RF link, at block 740.

Specifically, the I/Q baseband data can be collected, via a mobile measurement instrument 220, as shown in FIG. 2B, by receiving an RF signal transmitted from one or more base stations 210, as shown in FIG. 2B, at specified locations over a specified time period, and then down-converting the RF signal into I/Q baseband data for digital storage/recording on, for example, a computer readable medium, during block 710. Such I/Q baseband data can then downloaded into the mobile testing device 310, shown in FIG. 3, via a computer (not show) either connected directly to the mobile testing device 310 or indirectly, via a network such as the Internet, during block 720. A high-frequency RF signal is then generated and transmitted, via a RF link, to a wireless device 320, shown in FIG. 3, based on I/Q baseband data along with the standard (essential) protocol required for the wireless device to decode the RF signal upon its receipt, during block 730. Lastly, based on a RF signal sent back from the wireless device, via the RF link, testing of the wireless device can be performed at the mobile testing device 310, during block 740.

As previously discussed, such testing includes bit error rate (BER), block error rate (BLER), video-call connection, real-time data transfer, SMS, MMS, data security testing, and benchmarking new mobile phones in accordance with major cellular communications standards including GSM, W-CDMA, TD-SCDMA, CDMA2000, FDMA, TDMA, EDGE, HSDPA, HSUPA and WLAN standards.

Various components of the testing system, such as the arbitrary waveform generator, the wireless transceiver module, and the frequency converter, as shown in FIG. 4, can be implemented in software or hardware, such as, for example, an application specific integrated circuit (ASIC) or printed circuit board (PCB). As such, it is intended that the processes described herein be broadly interpreted as being equivalently performed by software, hardware, or a combination thereof. Software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs), CD-R, CD-R/W or digital video discs (DVDs), DVD-R/W, HD-DVD, Blu-ray and other advanced optical disks (AODs). Instructions of the software routines or modules may also be loaded or transported into the testing device on a network (wire or wireless) in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

As described from the foregoing, the present invention provides a testing system and methods in which digital data representing an actual fading profile of a selected geographic location can be obtained in advance, and a wireless device can be accurately for functionality at a mobile testing device using the actual fading profile. As a result, all types of testing including BER, video-call testing or real-time data transfer, error resilience tolerance over video streamlining data for a specific geographic location, such as Hong Kong environment (urban, suburban, underground, highway, etc..) can be performed accurately and reliably.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the components of the testing device can be implemented in a single hardware or firmware installed at an existing wireless card to perform the functions as described. In addition, a remote control system can also be set up at a laboratory, research center or testing center to connect to the network, such as the Internet, as shown in FIG. 3, in order to access the testing device 310, and control all functionalities of the testing device 310. In addition, wireless devices, such as mobile phones or personal digital assistants (PDAs), can also be controlled at the laboratory, research center or testing center, via a network (wire or wireless). Furthermore, alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Furthermore, both the software modules as described can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

What is claimed is:

1. A testing system for testing a wireless device comprising:
a testing device arranged to receive digital data representing an actual fading profile of a selected geographic region, the testing device generating test signals to perform testing of the wireless device using the actual fading profile.

2. The testing system as claimed in claim 1, further comprising a computer arranged to connect directly with the testing device, via a cable, to download digital data representing an actual fading profile of the selected geographic region that are collected at one or more locations in the selected geographic region over a designated time period, into the testing device.

3. The testing system as claimed in claim 1, further comprising a computer arranged to connect with the testing device, via a network, to download digital data representing an actual fading profile of the selected geographic region that are collected at one or more locations in the selected geographic region over a designated time period, into the testing device.

4. The testing system as claimed in claim 1, wherein the testing device receives the digital data representing an actual fading profile of the selected geographic region that are collected at one or more locations in the selected geographic region over a designated time period, from a computer readable medium.

5. The testing system as claimed in claim 1, wherein the testing device is provided with an arbitrary waveform generator to generate an analog baseband signal based on the digital data representing an actual fading profile, and a frequency converter to convert the analog baseband signal into a high-frequency RF signal suitable for transmission, via a transmission channel, to the wireless device, along with a standard protocol required for the wireless device to decode the RF signal upon its receipt.

6. The testing system as claimed in claim 5, wherein the wireless device is configured to receive and decode the RF signal according to the standard protocol transmitted from the testing device, and then send back to the testing device an RF signal for bit error rate (BER) testing.

7. The testing system as claimed in claim 1, wherein the wireless device is a mobile phone, and the testing includes bit error rate (BER), block error rate (BLER), video-call connection, real-time data transfer, SMS, MMS, data security testing, and benchmarking a new mobile phone in accordance with major cellular communications standards including GSM, W-CDMA, TD-SCDMA, CDMA2000, FDMA, TDMA, EDGE, HSDPA, HSUPA and WLAN standards.

8. The testing system as claimed in claim 1, wherein the testing device comprises:
a memory to store digital data representing an actual fading profile of a selected geographic region that are collected at one or more locations in the selected geographic region over a designated time period;
an arbitrary waveform generator to generate an analog baseband signal based on the digital data stored in the memory;
an RF transceiver arranged to convert the analog baseband signal into a high-frequency RF signal, to transmit the RF signal, via one or more RF ports, to a wireless device along with a standard protocol required for the wireless device to decode the RF signal upon its receipt, and to receive a RF signal sent back from the wireless device; and
a controller configured to perform testing of the wireless device based on the RF signal sent back from the wireless device.

9. The testing system as claimed in claim 8, wherein the testing includes bit error rate (BER), block error rate (BLER), video-call connection, real-time data transfer, SMS, MMS, data security testing, and benchmarking a new mobile phone in accordance with major cellular communications standards including GSM, W-CDMA, TD-SCDMA, CDMA2000, FDMA, TDMA, EDGE, HSDPA, HSUPA and WLAN standards.

10. The testing system as claimed in claim 8, wherein the wireless device is configured to receive and decode the RF signal according to the standard protocol transmitted from the testing device, and then send back to the testing device an RF signal for bit error rate (BER) testing.

11. A mobile testing station, comprising:
a memory to store digital data representing an actual fading profile of a selected geographic region;
an arbitrary waveform generator to generate an analog baseband signal based on the digital data stored in the memory;
an RF transceiver arranged to convert the analog baseband signal into a high-frequency RF signal, to transmit the RF signal, via one or more RF ports, to a wireless device along with a standard protocol required for the wireless device to decode the RF signal upon receipt, and to receive a RF signal sent back from the wireless device; and
a controller configured to perform testing of the wireless device based on the RF signal sent back from the wireless device.

12. The mobile testing station as claimed in claim 11, wherein the testing includes bit error rate (BER), block error rate (BLER), video-call connection, real-time data transfer, SMS, MMS, data security testing, and benchmarking a new mobile phone in accordance with major cellular communications standards including GSM, W-CDMA, TD-SCDMA, CDMA2000, FDMA, TDMA, EDGE, HSDPA, HSUPA and WLAN standards.

13. The mobile testing station as claimed in claim 12, wherein the digital data representing an actual fading profile of the selected geographic region that are collected at one or more locations in the selected geographic region, are downloaded into the memory from a remote computer directly by a user, or via a network.

14. The mobile testing station as claimed in claim 11, wherein the wireless device corresponds to one of a mobile phone, a personal digital assistant (PDA), and a pager.

15. A method for testing a wireless device utilizing a mobile testing station, comprising:
obtaining digital data representing an actual fading profile of a selected geographic region;
generating an analog baseband signal based on the digital data obtained;
converting the analog baseband signal into a high-frequency RF signal, and transmitting the RF signal, via a RF link, to a wireless device along with a standard protocol required for the wireless device to decode the RF signal upon receipt; and
performing testing of the wireless device based on a RF signal sent back from the wireless device, via the RF link.

16. The method as claimed in claim 15, wherein the testing includes bit error rate (BER), block error rate (BLER), video-call connection, real-time data transfer, SMS, MMS, data security testing, and benchmarking a new mobile phone in accordance with major cellular communications standards including GSM, W-CDMA, TD-SCDMA, CDMA2000, FDMA, TDMA, EDGE, HSDPA, HSUPA and WLAN standards.

17. The method as claimed in claim 16, wherein the digital data representing an actual fading profile of the selected geographic region that are collected at one or more locations in the selected geographic region, are obtained from a remote computer directly by a user, or via a network.

18. A computer readable medium comprising a plurality of instructions which, when executed by a mobile testing station, perform the steps of:
obtaining digital data representing an actual fading profile of a selected geographic region;
generating an analog baseband signal based on the digital data obtained;
converting the analog baseband signal into a high-frequency RF signal, and transmitting the RF signal, via a RF link, to a wireless device along with a standard protocol required for the wireless device to decode the RF signal upon receipt; and
performing functional testing of the wireless device based on a RF signal sent back from the wireless device, via the RF link.

19. The computer readable medium as claimed in claim 18, wherein the testing includes bit error rate (BER), block error rate (BLER), video-call connection, real-time data transfer, SMS, MMS, data security testing, and benchmarking a new mobile phone in accordance with major cellular communications standards including GSM, W-CDMA, TD-SCDMA, CDMA2000, FDMA, TDMA, EDGE, HSDPA, HSUPA and WLAN standards.

20. The computer readable medium as claimed in claim 18, wherein the digital data represent RF signals collected at one or more locations in the selected geographic region, and are obtained from a remote computer directly by a user, or via a network.
